(19) United States
(12) Patent Application Publication
(10) Pub. No.: US 2025/0300337 A1
(43) Pub. Date: Sep. 25, 2025

(54) Miniaturized Microstrip Filter with Low Insertion Loss, Low Cost, and Multiple Zeros

(71) Applicant: Micronet Union Technology (Chengdu) Co., Ltd., Chengdu (CN)

(72) Inventors: Tao Chen, Chengdu (CN); Yingchuan Luo, Chengdu (CN); Zhiwei Kang, Chengdu (CN); Yuandan Dong, Chengdu (CN); Junhong Cai, Chengdu (CN); Liyun Liu, Chengdu (CN); Zhen Jiang, Chengdu (CN)

(21) Appl. No.: 18/930,987

(22) Filed: Oct. 30, 2024

(30) Foreign Application Priority Data
Mar. 19, 2024 (CN) 2024103095774

(51) Int. Cl. H01P 1/20; H01P 3/08

(52) U.S. Cl. CPC H01P 1/20; H01P 3/081

(57) ABSTRACT

The present disclosure provides a miniaturized microstrip filter with a low insertion loss, a low cost, and multiple zeros and belongs to the field of radio frequency microwaves. The miniaturized microstrip filter includes a dielectric substrate and a vertically folded stepped impedance resonator. The vertically folded stepped impedance resonator is located in a middle of the dielectric substrate, and coplanar waveguide transmission ports connected to the vertically folded stepped impedance resonator are disposed on both two sides of a lower surface of the dielectric substrate. The vertically folded stepped impedance resonator includes a folded low impedance line and a high impedance line, the low impedance line is disposed on an upper surface of the dielectric substrate, the high impedance line is disposed on the lower surface of the dielectric substrate, and the two are connected through a metalized via hole to form the small-size vertically folded stepped impedance resonator.

### TECHNICAL FIELD

The present disclosure relates to the field of radio frequency microwaves, in particular to a miniaturized microstrip filter with a low insertion loss, a low cost, and multiple zeros.

### BACKGROUND

As spectrum resources are more and more finely divided, the number of filters used in a wireless system is increasing, their performance requirements are becoming higher and higher, and filters with low loss, deep suppression, low cost, and high integration are becoming more and more popular. As a widely used filter, a microstrip filter has advantages of low cost, easy planar integration, design flexibility, etc.

Existing technologies for obtaining small-size filters mainly include 1) bending resonators in the same plane; 2) a multilayer structure, where a plurality of resonators are stacked in multiple layers in a vertical coupling mode, such as a dielectric substrate integrated suspended microstrip line technology; 3) adoption of a processing technology for a high dielectric constant dielectric substrate, such as a low temperature co-fired ceramic technology; and 4) adoption of a multi-mode resonator to obtain a response effect of a plurality of resonators without increasing the number of resonators. These advantages of miniaturization are achieved at the same time that indicators such as cost, design simplicity, and longitudinal dimensions deteriorate. Moreover, in addition to changing a structure of a filter itself to obtain a small size, the number of filters used is also reduced by expanding operating frequency bands of a multi-passband filter operating in a multi-frequency system. In a filter design, in addition to ensuring a passband performance, a higher out-of-band suppression degree needs to be obtained as much as possible, which is usually improved by creating transmission zeros out of band or by increasing the order of a filter. In a conventional filter design, the number of zeros generated is small, generally no more than the order of the filter minus two, and increasing the order of the filter will bring about a greater loss, so the number of zeros out of band is often insufficient, resulting in an insufficiently wide stopband range and an insufficiently deep suppression degree. In addition to this, a stopband may be broadened by staggering higher modes of each resonator, but the design flexibility of this method will be gradually decreased as the order is increased.

When a miniaturized high-performance filter is designed, a stacking mode of multilayer dielectric substrates sacrifices planarization requirements in a vertical direction for a size reduction in a horizontal direction, and an increase in the number of substrates will also bring about an increase in a manufacturing cost. In a multilayer printed circuit board, fixing is often done by pins for mounting the multilayer substrates, which will reduce relative positional accuracy in the vertical direction, thus affecting the performance of the filter. Secondly, bending the resonators in the same layer results in a limited degree of size reduction and will increase the difficulty in adjusting the coupling strength between the resonators. In addition, when the multi-mode resonator is used, its adjustment flexibility will be reduced due to the presence of a plurality of modes in the resonator that affect coupling with each other. Other novel processing technologies, such as the low temperature co-fired ceramic technology, are not as mature as a printed circuit board technology, so their processing costs are more expensive, especially in a multilayer design where a cost issue is more obvious.

The conventional mode of increasing the out-of-band suppression degree by increasing the order of the filter will result in an increase in an in-passband loss due to a longer signal transmission path, and the increase of the order complicates the design and makes the size of the filter larger. In addition, there are also some drawbacks to obtaining a wider stopband by staggering resonance frequencies of the higher modes, and it is more difficult to stagger the higher modes so that a higher passband does not arise when the order of the filter is required to be higher. Moreover, the method of adjusting the frequency of the higher modes is generally to change a shape of the resonator, which also interferes with a fundamental frequency of the resonator and the coupling strength of a coupling position between the resonators, making the overall adjustment more inconvenient.

### SUMMARY

An objective of the present disclosure is to overcome shortcomings of the prior art. A miniaturized microstrip filter with a low insertion loss, a low cost, and multiple zeros is provided, which solves problems existing in the prior art.

The objective of the present disclose is implemented through the following technical solution. A miniaturized microstrip filter with a low insertion loss, a low cost, and multiple zeros includes a dielectric substrate and a vertically folded stepped impedance resonator. The vertically folded stepped impedance resonator is located in a middle of the dielectric substrate, and coplanar waveguide transmission ports connected to the vertically folded stepped impedance resonator are disposed on both two sides of a lower surface of the dielectric substrate.

The vertically folded stepped impedance resonator includes a folded low impedance line and a high impedance line, the low impedance line is disposed on an upper surface of the dielectric substrate, the high impedance line is disposed on the lower surface of the dielectric substrate, and the two are connected through a metalized via hole to form the small-size vertically folded stepped impedance resonator. A position with a strongest electric field distribution and a position with a strongest magnetic field distribution in the vertically folded stepped impedance resonator are isolated in different layers by the low impedance line and the high impedance line to realize independent controls of an electric coupling and a magnetic coupling.

Metal grounds are disposed on two sides of the upper surface and on the lower surface of the dielectric substrate, and each of the metal grounds on the two sides of the upper surface is provided with a row of metalized via holes to surround the vertically folded stepped impedance resonator, and is connected to the metal ground on the lower surface through the metalized via holes.

Two low impedance lines are disposed on the upper surface of the dielectric substrate and are cross-folded in a cross shape, and two high impedance lines are disposed on the lower surface of the dielectric substrate. The two high impedance lines are connected to the low impedance lines through the metalized via holes to form two vertically folded stepped impedance resonators of two half wavelengths arranged in parallel, and the coplanar waveguide transmission ports disposed on the two sides of the lower surface of the dielectric substrate are connected to one of the high impedance lines respectively.

The two low impedance lines in the vertically folded stepped impedance resonators of the two half wavelengths have different areas, which generate two transmission zeros, a hybrid coupling is performed on the vertically folded stepped impedance resonators of the two half wavelengths to form a passband, and since strengths of two pairs of formed hybrid couplers are different, other two transmission zeros are generated.

Four low impedance lines are disposed on the upper surface of the dielectric substrate, and two high impedance lines are disposed on the lower surface of the dielectric substrate. The four low impedance lines are connected to the two high impedance lines through metalized via holes, each high impedance line is connected to a metal ground through a grounding branch to form four vertically folded stepped impedance resonators of a quarter wavelength arranged in a square, and the coplanar waveguide transmission ports disposed on the two sides of the lower surface of the dielectric substrate are connected to one of the high impedance lines respectively.

Each pair of vertically folded stepped impedance resonators of the quarter wavelength constitutes a passband path, an electric coupling is formed between the low impedance lines in each pair of vertically folded stepped impedance resonators, and a coupling strength is adjusted by adjusting a size of a gap between the two low impedance lines.

There is a hybrid coupling between the two passband paths, an electric coupling is controlled and adjusted through the low impedance lines, a magnetic coupling is controlled and adjusted through the grounding branches, thus two transmission zeros are generated between the two passbands, and the two grounding branches are close to each other to form a source-load coupling and introduce more transmission zeros.

The present disclosure has following advantages. In the miniaturized microstrip filter with a low insertion loss, a low cost, and multiple zeros, high-impedance and low-impedance portions of the resonator are folded on upper and lower layers of the same layer of substrate and are connected through the metal via hole to obtain the vertically folded stepped impedance resonator, which reduces a size of the resonator and allows couplings of the electric field and the magnetic field of the resonator to be independently controlled. The vertically folded stepped impedance resonators of the half wavelength are designed asymmetrically, so that two series resonance loops generated by themselves in parallel to ground do not have the same resonance frequency, thus generating two zeros to improve stopband characteristics. At the same time, the hybrid coupling is utilized to generate two zeros, thus realizing that the filter generates four transmission zeros in a low order response of a second order to obtain a good stopband performance. The resonators of the quarter wavelength are formed by adding the grounding branches to the asymmetric resonators of the half wavelength, a dual-passband response is formed by utilizing a structure similar to that of the single-passband filter, and frequencies and bandwidths of the two passbands can be flexibly adjusted.

### BRIEF DESCRIPTION OF DRAWINGS

FIG. 1 is a top view of a single-passband bandpass filter in the present disclosure.

FIG. 2 is a bottom view of a single-passband bandpass filter in the present disclosure.

FIG. 3 is a front view of a single-passband bandpass filter in the present disclosure.

FIG. 4 is a top view of a dual-passband bandpass filter in the present disclosure.

FIG. 5 is a bottom view of a dual-passband bandpass filter in the present disclosure.

FIG. 6 is a front view of a dual-passband bandpass filter in the present disclosure.

In the figures: 1-coplanar waveguide transmission port, 2-vertically folded stepped impedance resonator, 3-metal ground, 4-metalized via hole, 5-grounding branch, 6-low impedance line, 7-high impedance line, and 8-dielectric substrate.

### DETAILED DESCRIPTION

In order to make an objective, a technical solution and advantages of the present application clearer, the technical solution in embodiments of the present application will be clearly and completely described below in combination with accompanying drawings in the embodiments of the present application. Apparently, the described embodiments are only part of the embodiments of the present application, not all of them. Components of the embodiments of the present application generally described and illustrated in the accompanying drawings herein may be arranged and designed in various different configurations. Therefore, the following detailed description of the embodiments of the present application provided in combination with the accompanying drawings is not intended to limit the claimed scope of protection of the present application, but rather only represents selected embodiments of the present application. Based on the embodiments of the present application, all other embodiments obtained by those of ordinary skill in the art without making creative work belong to the scope of protection of the present application. The present disclosure is further described below in combination with the accompanying drawings.

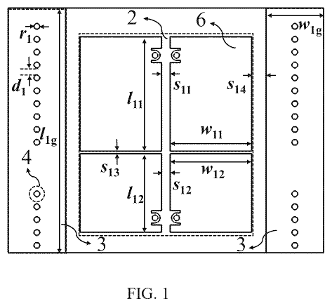

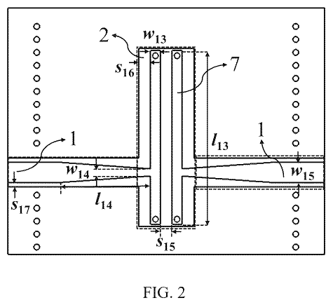

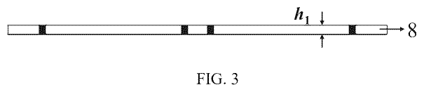

As shown in FIG. 1-FIG. 3, an implementation of the present disclosure relates to a miniaturized single-passband bandpass filter with a low insertion loss, a low cost, and multiple zeros, including a dielectric substrate 8 and a vertically folded stepped impedance resonator 2. The vertically folded stepped impedance resonator 2 is located in a middle of the dielectric substrate 8, and coplanar waveguide transmission ports 1 connected to the vertically folded stepped impedance resonator 2 are disposed on both two sides of a lower surface of the dielectric substrate 8. The coplanar waveguide transmission port 1 located on the left side of the dielectric substrate 8 serves as an input port, and the coplanar waveguide transmission port 1 on the other side serves as an output port.

Metal grounds 3 are disposed on two sides of an upper surface and on the lower surface of the dielectric substrate 8, and each of the metal grounds 3 on the two sides of the upper surface is provided with a row of metalized via holes 4 to surround the vertically folded stepped impedance resonator 2, and is connected to the metal ground 3 on the lower surface through the metalized via holes 4.

A diameter of the metalized via holes 4 is 0.12 mm, and spacing of the via holes is 0.5 mm and 0.2 mm respectively. The dielectric substrate 8 is a Rogers5880 substrate with a thickness of 0.508 mm, a dielectric constant of 2.2, and a loss angle tangent of 0.0009.

Further, two low impedance lines 6 are disposed on the upper surface of the dielectric substrate 8 and are cross-folded in a cross shape, and two high impedance lines 7 are disposed on the lower surface of the dielectric substrate 8. The two high impedance lines 7 are connected to the low impedance lines 6 through metalized via holes 4 to form two vertically folded stepped impedance resonators 2 of two half wavelengths arranged in parallel, and the coplanar waveguide transmission ports disposed on the two sides of the lower surface of the dielectric substrate 8 are connected to one of the high impedance lines 7 respectively.

In the present embodiment, the stepped impedance resonators are folded vertically with the high impedance lines 7 and the low impedance lines 6 as dividing lines, so that two portions thereof are distributed on upper and lower layers of the same layer of dielectric substrate 8, and then connected through the metalized via holes 4. This method realizes miniaturization while a position with a strongest electric field distribution and a position with a strongest magnetic field distribution in the resonators are isolated in different layers, thus realizing independent controls of an electric coupling and a magnetic coupling between resonators, and therefore a design is more flexible. In addition to this, the vertically folded stepped impedance resonators 2 of the half wavelength is used in the filter, and may be equivalent to two series LC circuits connected in parallel to ground, so that the resonators themselves may generate transmission zeros, and then the individual resonators are asymmetrically processed so that the two low impedance lines 6 of the resonators do not have the same area, thus obtaining two zeros. Based on a resonator principle above, a hybrid coupling is performed on the two resonators to form a passband, and a feed structure uses the coplanar waveguide transmission ports 1 to be directly connected to the high impedance lines 7, which allows the metal grounds 3 to be located in the same metal layer as the high impedance lines 7 to maintain characteristics of the single-layer substrate of the filter. Since strengths of two pairs of formed hybrid couplings are different, two zeros may also be formed. Based on the above design principle, a design of the miniaturized filter with multiple zeros may be obtained, and because the order of the filter is not increased while introducing zeros, an advantage of a low insertion loss can be realized at the same time.

A working principle process of the present embodiment is: a 50-ohm coplanar waveguide feed line is connected to the portion of the high impedance lines 7 of the vertically folded stepped impedance resonators 2 to excite them, the two vertically folded stepped impedance resonators 2 form the hybrid couplings through the low impedance lines 6 and the parallel-coupled high impedance lines 7 on the lower layer, and finally, a signal is transmitted through a symmetrical structure to the output port. Four transmission zeros are introduced by structural characteristics of the vertically folded stepped impedance resonators 2 of the half wavelength themselves and the hybrid couplings between the two resonators.

Individual parameters of the single-passband bandpass filter are as shown in Table 1 below:

TABLE 1
Parameters of single-passband bandpass
filter (unit: mm)

| l₁₁ | w₁₁ | l₁₂ | w₁₂ | l₁₃ | w₁₃ | l₁₄ |
|---|---|---|---|---|---|---|
| 8 | 5.7 | 5.5 | 5.7 | 12.05 | 0.7 | 6.3 |
| w₁₄ | w₁₅ | l_{1g} | w_{1g} | s₁₁ | s₁₂ | s₁₃ |
| 0.5 | 1.4 | 17 | 4 | 0.6 | 0.6 | 0.15 |
| s₁₄ | s₁₅ | s₁₆ | s₁₇ | r₁ | d₁ | h₁ |
| 1 | 0.8 | 0.825 | 0.3 | 0.2 | 0.5 | 0.508 |

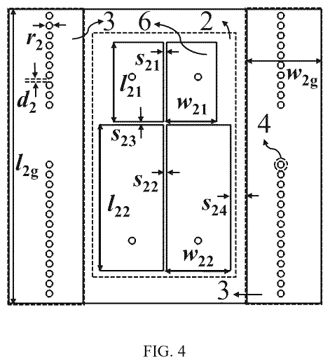

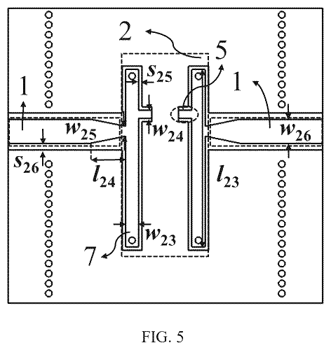

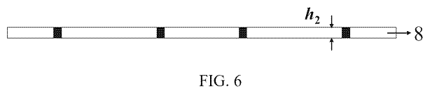

As shown in FIG. 4-FIG. 6, another implementation of the present disclosure relates to a miniaturized dual-passband bandpass filter with a low insertion loss, a low cost, and multiple zeros, including a dielectric substrate 8 and vertically folded stepped impedance resonators 2. The vertically folded stepped impedance resonators 2 are located in a middle of the dielectric substrate 8, and coplanar waveguide transmission ports 1 connected to the vertically folded stepped impedance resonators 2 are disposed on both two sides of a lower surface of the dielectric substrate 8. The coplanar waveguide transmission port 1 located on the left side of the dielectric substrate 8 serves as an input port, and the coplanar waveguide transmission port 1 on the other side serves as an output port.

Metal grounds 3 are disposed on two sides of an upper surface and on the lower surface of the dielectric substrate 8, and each of the metal grounds 3 on the two sides of the upper surface is provided with a row of metalized via holes 4 to surround the vertically folded stepped impedance resonator 2, and is connected to the metal ground 3 on the lower surface through the metalized via holes 4.

A diameter of the metalized via holes 4 is 0.12 mm, and spacing of the via holes is 0.5 mm and 0.2 mm respectively. The dielectric substrate 8 is a Rogers5880 substrate with a thickness of 0.508 mm, a dielectric constant of 2.2, and a loss angle tangent of 0.0009.

Four low impedance lines 6 are disposed on the upper surface of the dielectric substrate 8, and two high impedance lines 7 are disposed on the lower surface of the dielectric substrate 8. The four low impedance lines 6 are connected to the two high impedance lines 7 through the metalized via holes 4, each high impedance line 7 is connected to a metal ground 3 through a grounding branch 5 to form four vertically folded stepped impedance resonators 2 of a quarter wavelength arranged in a square, and the coplanar waveguide transmission ports disposed on the two sides of the lower surface of the dielectric substrate 8 are connected to one of the high impedance lines 7 respectively.

In the present embodiment, based on the design of the single-passband filter above, the portion of the high impedance lines 7 of the vertically folded stepped impedance resonators of the half wavelength is grounded through the grounding branches 5, so that four vertically folded stepped impedance resonators 2 of the quarter wavelength are realized in a similar structure. Each of two passband paths of the dual-passband filter is composed of a pair of resonators of the quarter wavelength, and an electric coupling is formed between the low impedance lines 6 of each pair of vertically folded stepped impedance resonators 2, the strength of which can be controlled by a size of a gap, so that a resonance frequency of the corresponding passband can be adjusted by adjusting sizes of different pairs of vertically folded stepped impedance resonators 2. The hybrid couplings exist between the two paths, wherein the electric coupling and the magnetic coupling are independently controlled by the low impedance lines 6 and the grounding branches 5 respectively, and the two zeros between the two passbands are generated as a result. The two grounding branches 5 are close to each other to form a weak source-load coupling and introduce more zeros. A feed structure is similar to the structure of the single-passband filter in that both have the coplanar waveguide transmission ports 1 directly connected to the high impedance lines 7. From the above analysis, the miniaturized dual-passband filter with a low insertion loss similar to the single-passband structure is obtained and has four transmission zeros and a flexible adjustment of a passband response.

A working principle process of the present embodiment is: a 50-ohm coplanar waveguide feed line is connected to the portion of the high impedance lines 7 through the coplanar waveguide transmission ports 1, and the resonators on the left side of the two paths are both excited, and then form an electric coupling with the resonators of the same size arranged side by side through the low impedance lines 6, and an output feed line is directly connected to an output signal to obtain two passbands. The hybrid couplings are formed between the two paths through the low impedance lines 6 and the grounding branches 5 respectively, and the input and output feed lines form a weak magnetic coupling through the grounding branches 5 close to each other, whereby four transmission zeros are introduced to enable the stopband performance of the filter to be improved.

Individual parameters of the dual-passband bandpass filter are as shown in Table 2 below:

TABLE 2
Parameters of dual-passband bandpass
filter (unit: mm)

| l₂₁ | w₂₁ | l₂₂ | w₂₂ | l₂₃ | w₂₃ | l₂₄ |
|---|---|---|---|---|---|---|
| 8.8 | 3.86 | 4.8 | 3.02 | 10.62 | 0.8 | 2.1 |
| w₂₄ | w₂₅ | l_{2g} | w₂₆ | w_{2g} | s₂₁ | s₂₂ |
| 0.5 | 0.6 | 17.7 | 1.44 | 4.5 | 0.12 | 0.12 |
| s₂₃ | s₂₄ | s₂₅ | s₂₆ | r₂ | d₂ | h₂ |
| 0.12 | 1 | 0.2 | 0.4 | 0.2 | 0.2 | 0.508 |

The foregoing is only a preferred implementation of the present disclosure, and it should be understood that the present disclosure is not limited to the form disclosed herein and should not be regarded as an exclusion of other embodiments, but can be used for various other combinations, modifications and improvements, and can be modified within the scope of the conception described herein by the foregoing teachings or technology or knowledge in the relevant field. Alterations and changes made by persons in the art do not deviate from the spirit and scope of the present disclosure, and shall be within the scope of protection of the claims appended to the present disclosure.

What is claimed is:

1. A miniaturized microstrip filter with a low insertion loss, a low cost, and multiple zeros, comprising a dielectric substrate (8) and a vertically folded stepped impedance resonator (2); wherein the vertically folded stepped impedance resonator (2) is located in a middle of the dielectric substrate (8), and coplanar waveguide transmission ports (1) connected to the vertically folded stepped impedance resonator (2) are disposed on both two sides of a lower surface of the dielectric substrate (8); and
the vertically folded stepped impedance resonator (2) comprises a folded low impedance line (6) and a high impedance line (7), the low impedance line (6) is disposed on an upper surface of the dielectric substrate (8), the high impedance line (7) is disposed on the lower surface of the dielectric substrate (8), the two are connected through a metalized via hole (4) to form the small-size vertically folded stepped impedance resonator (2), and a position with a strongest electric field distribution and a position with a strongest magnetic field distribution in the vertically folded stepped impedance resonator (2) are isolated in different layers by the low impedance line (6) and the high impedance line (7) to realize independent controls of an electric coupling and a magnetic coupling.

2. The miniaturized microstrip filter with a low insertion loss, a low cost, and multiple zeros according to claim 1, wherein metal grounds (3) are disposed on two sides of the upper surface and on the lower surface of the dielectric substrate (8), and each of the metal grounds (3) on the two sides of the upper surface is provided with a row of metalized via holes (4) to surround the vertically folded stepped impedance resonator (2), and is connected to the metal ground (3) on the lower surface through the metalized via holes (4).

3. The miniaturized microstrip filter with a low insertion loss, a low cost, and multiple zeros according to claim 1, wherein two low impedance lines (6) are disposed on the upper surface of the dielectric substrate (8) and are cross-folded in a cross shape, two high impedance lines (7) are disposed on the lower surface of the dielectric substrate (8), the two high impedance lines (7) are connected to the low impedance lines (6) through metalized via holes (4) to form two vertically folded stepped impedance resonators (2) of two half wavelengths arranged in parallel, and the coplanar waveguide transmission ports (1) disposed on the two sides of the lower surface of the dielectric substrate (8) are connected to one of the high impedance lines (7) respectively.

4. The miniaturized microstrip filter with a low insertion loss, a low cost, and multiple zeros according to claim 3, wherein the two low impedance lines (6) in the vertically folded stepped impedance resonators (2) of the two half wavelengths have different areas, which generate two transmission zeros, a hybrid coupling is performed on the vertically folded stepped impedance resonators (2) of the two half wavelengths to form a passband, and since strengths of two pairs of formed hybrid couplers are different, other two transmission zeros are generated.

5. The miniaturized microstrip filter with a low insertion loss, a low cost, and multiple zeros according to claim 1, wherein four low impedance lines (6) are disposed on the upper surface of the dielectric substrate (8), two high impedance lines (7) are disposed on the lower surface of the dielectric substrate (8), the four low impedance lines (6) are connected to the two high impedance lines (7) through metalized via holes (4), each high impedance line (7) is connected to a metal ground (3) through a grounding branch (5) to form four vertically folded stepped impedance resonators (2) of a quarter wavelength arranged in a square, and the coplanar waveguide transmission ports (1) disposed on the two sides of the lower surface of the dielectric substrate (8) are connected to one of the high impedance lines (7) respectively.

6. The miniaturized microstrip filter with a low insertion loss, a low cost, and multiple zeros according to claim 5, wherein each pair of vertically folded stepped impedance resonators (2) of the quarter wavelength constitutes a passband path, an electric coupling is formed between the low impedance lines (6) in each pair of vertically folded stepped impedance resonators (2), and a coupling strength is adjusted by adjusting a size of a gap between the two low impedance lines (6).

7. The miniaturized microstrip filter with a low insertion loss, a low cost, and multiple zeros according to claim 6, wherein there is a hybrid coupling between the two passband paths, an electric coupling is controlled and adjusted through the low impedance lines (6), a magnetic coupling is controlled and adjusted through the grounding branches (5), thus two transmission zeros are generated between the two passbands, and the two grounding branches (5) are close to each other to form a source-load coupling and introduce more transmission zeros.
